(19) United States
(12) Patent Application Publication
(10) Pub. No.: US 2023/0202717 A1
(43) Pub. Date: Jun. 29, 2023

(54) Multi-Purpose Bucket Handle Tool

(71) Applicant: Andrew James Yorgey, Cape Coral, FL (US)

(72) Inventor: Andrew James Yorgey, Cape Coral, FL (US)

(21) Appl. No.: 17/564,838

(22) Filed: Dec. 29, 2021

(51) Int. Cl. B65D 25/32; B67B 7/00

(52) U.S. Cl. CPC B65D 25/32; B67B 7/00; B44D 3/14

(57) ABSTRACT

The present invention relates to an improved, durable, economic, simple, and multipurpose bucket handle tool which comprises a channel to snap onto a standard bucket handle by a plurality of magnets, a plurality of indentations provided that conform to a user's hand to make a perfect grip, and a lid opener to open a lid of a bucket. The main aim of the present invention is to provide the multipurpose bucket handle tool which is easily snapped on and off to the standard bucket handle, and is designed ergonomically so that the user can carry the bucket with minimal hand fatigue or discomfort.

### FIELD OF THE INVENTION

The present invention relates primarily to a bucket handle tool and more particularly it relates to a multipurpose bucket handle tool having an ergonomic design, provided to snap on to a standard bucket handle via a channel and a plurality of magnets.

### BACKGROUND OF THE INVENTION

Buckets are commonly used in various trades for carrying and storing various solvents, chemicals, paints, etc. The buckets are generally equipped with a handle for holding and carrying it with a large quantity of such products for larger jobs without being overly burdensome. However, the weight of such products makes these buckets somewhat difficult to manage, especially when they are full. Due to the weight, the handle may dig into the user's hand when he is carrying the bucket. A small plastic grip is sometimes provided on the handle to lessen the stress on the user's hand, but these grips are typically not enough to significantly alleviate the discomfort of carry the buckets because they are not wide enough and do not adequately conform to the hand of the user.

Various prior arts have been disclosed which describe about different types of bucket handle accessories. A prior art U.S. Pat. No. 4,823,433A discloses an elongate grip or handle member for grasping in the hand by a user, with the gripper handle member including a groove extending generally the length of the member along the top side, wherein the groove is dimensioned to receive the wire loop handle of a conventional paint bucket. The elongate grip or handle member enables lifting and holding the paint bucket without the discomfort of the wire loop handle pressing directly against the user's hand.

Another prior art U.S. Pat. No. 7,805,813B1 is disclosing a grip for use with a bail coupled to a container which includes an elongate tubular body for extending along a portion of the bail. The body has first and second opposite end portions and a central portion, wherein the central portion can be grasped by a user and has a diameter of at least one inch. The first and second end portions have respective first and second engagement surfaces for contacting the bail in spaced-apart positions. The bail extends free of the body between the first and second engagement surfaces.

Still another prior art U.S. Pat. No. 9,914,560B2 discloses about a handle for attachment to a bail member of a bucket, wherein the handle includes a base structure formed from two interlocking members, a first member includes a projection, tab, or the like protrusion along an inner side surface. A second member includes a catch or the like receptacle along an inner surface for receipt of the first member, thereby locking the two members together without tools.

Yet another prior art CA2745185A1 discloses carrying aids used with containers that include a wire bail pivotally attached to the container, wherein the carrying aids may include a body configured to engage the bail and be grasped by a grasping hand to suspend the container in a first position.

A design prior art U.S. D 807146S1 illustrates an ornamental design for a grip for a wire handle.

Although the abovementioned prior arts describe about the conventional gripping tools for the handle of the bucket, they do not apparently describe about the attachment of the gripping tool with the handle via a plurality of magnets, nor are they specifically tailored towards providing a means for opening a lid of the bucket.

Abovementioned prior arts are mainly focused on providing various types of gripping tools to be attached around the handle of the bucket. Whereas, the present invention discloses about a multipurpose bucket handle tool with a magnetic attachment arrangement along with a lid opener. The unique characteristics and features of the present invention are therefore, unrepresented within the prior arts.

The aforesaid conventional arts encounter various drawbacks and do not provide multipurpose gripping tool which is effective in all the defined functions. Hence, there is a significant need and void in the market to invent an improved, durable, economic, simple, and multipurpose bucket handle tool which is easily snapped on to the handle of the bucket via a channel and the plurality of magnets. Also, there is a need to invent a multipurpose bucket handle tool which is design ergonomically so that a user can carry the bucket with minimal hand fatigue or discomfort.

### SUMMARY OF THE INVENTION

The primary objective of the present invention is to provide an improved, durable, economic, simple, and multipurpose bucket handle tool which addresses the needs which were not fulfilled by the conventional arts.

Another objective of the present invention is to provide a multipurpose bucket handle tool which is designed uniquely and ergonomically to reduce a hand fatigue and provide maximum comfort to a user while carrying a large bucket.

Still another objective of the present invention is to provide a multipurpose bucket handle tool which has a plurality of magnets for a secure placement.

Still another objective of the present invention is to provide a multipurpose bucket handle tool which has a lid opener integrated in its body.

Still another objective of the present invention is to provide a multipurpose bucket handle tool which can be easily snapped on and snapped off therefrom.

Still another objective of the present invention is to provide a multipurpose bucket handle tool which can be easily stored.

Still another objective of the present invention is to provide a multipurpose bucket handle tool which can be applicable to handle of any large bucket.

The summary is provided to introduce representative objectives of the invention in a simplified form that are further described below in the detailed description. This summary is not intended to identify key features or essential features of the claimed subject matter, nor is it intended to be used in any way that would limit the scope of the claimed subject matter.

### BRIEF DESCRIPTION OF DRAWINGS

Other objects, advantages and novel features of the invention will become apparent from the following detailed description of the present embodiment when taken in conjunction with the accompanying drawings. These figures are not intended to limit the scope of the present invention but rather illustrate certain attributes thereof.

FIG. 1 illustrates an exploded view of a plurality of components of a multipurpose bucket handle tool according to an embodiment of the present invention.

FIG. 2 illustrates a perspective view of a multipurpose bucket handle tool according to an embodiment of the present invention.

FIG. 3 illustrates a top and bottom view of a multipurpose bucket handle tool respectively, according to an embodiment of the present invention.

FIG. 4 illustrates various side views of a multipurpose bucket handle tool according to an embodiment of the present invention.

FIG. 5 illustrates an exemplary view of a multipurpose bucket handle tool snapped on to a standard bucket handle, according to an embodiment of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The foregoing disclosure has broadly outlined the features and technical advantages of the present disclosure in order that the description of the disclosure that follows may be better understood. It should be appreciated by those skilled in the art that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objects and advantages will be better understood from the following description.

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

It is to be also understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

It is to be understood that the term “bucket” hereinafter refers to any large bucket which is used to carry and store many things including, but not limited to paints, solvents, and chemicals.

The present invention discloses an improved, durable, economic, simple, and multipurpose bucket handle tool which is easily snapped on to a standard bucket handle, and is designed ergonomically so that a user can carry a bucket with minimal hand fatigue or discomfort.

Reference will now be made in detail to a presently preferred embodiment of the invention, an example of which is illustrated in the accompanying drawings.

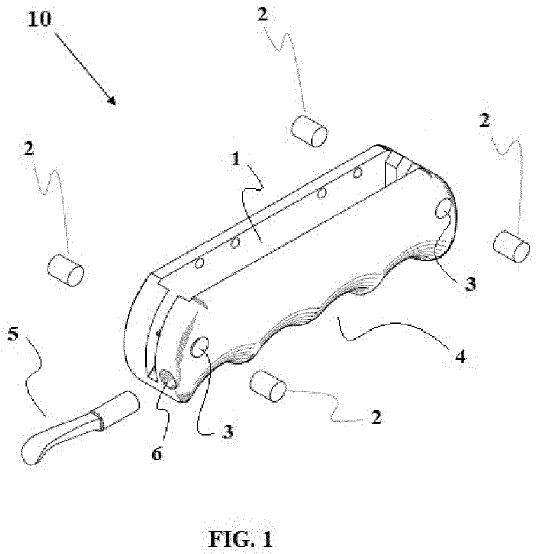

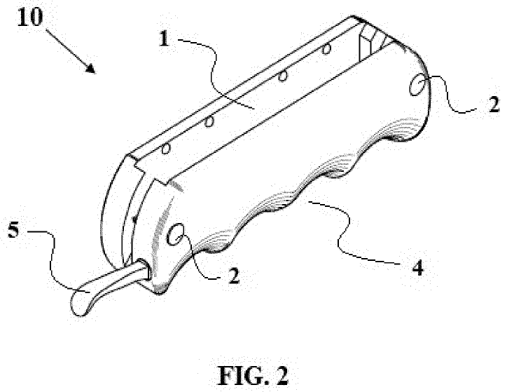

According to an exemplary embodiment of the present invention, an exploded view of a plurality of components of the multipurpose bucket handle tool 10 is shown in FIG. 1. Referring now to FIG. 1, the multipurpose bucket handle tool 10 is comprising: a channel 1 which is configured to securely snap onto the standard bucket handle, and be held at a place by a plurality of magnets 2; a plurality of apertures 3 provided to insert the plurality of magnets 2 for a secure placement of the multipurpose bucket handle tool 10 onto the standard bucket handle; a plurality of indentations 4 provided at an outer bottom of the multipurpose bucket handle tool 10, that conform to the user's hand to make a perfect grip with more ergonomic benefits; a lid opener 5 with a sharp end is extending outward from one of the side walls of the multipurpose bucket handle tool 10, and configured to open a lid of the bucket; and an aperture 6 is provided to securely place the lid opener 5 inside it. Further in FIG. 2, a perspective view of the multipurpose bucket handle tool 10 is shown with the plurality of components being positioned at defined locations.

According to an embodiment of the present invention, magnetic fields generated by the plurality of magnets 2 pass through to an interior of the channel 1, and grab on to the standard bucket handle, wherein the bucket handle is typically made up of a metal wire. Moreover, when the multipurpose bucket handle tool 10 is not in use, the plurality of magnets 2 are utilized to hold the multipurpose bucket handle tool 10 to anything which is attracted to the magnets 2. In this way, the plurality of magnets 2 fulfill dual purpose by being beneficial in both states, working state and non-working state of the multipurpose bucket handle tool 10.

According to an embodiment of the present invention, the lid opener 5 which is integrated in one of the side walls of the multipurpose bucket handle tool 10 has a main purpose of avoiding use of a separate lid opener. In most cases, the user needs to keep the separate lid opener with him every time and ends up with losing it, and needs to buy another one or borrow it from other user. Hence to avoid such inconvenience and unnecessary expense, a cost-effective solution disclosed by the present invention allows the user to open the lid of the bucket using the multipurpose bucket handle tool 10 itself via the lid opener 5 integrated in it. The multipurpose bucket handle tool 10 of the present invention is therefore, proven effective as well as efficient in carrying out the large bucket with ease and comfort, open the lid of the large bucket, and also storing itself at any place magnetic.

According to abovementioned embodiments of the present invention, the user for example, a painter who uses a large paint bucket for painting a surface. The painter oftentimes use paint directly from the bucket by dipping a brush into the bucket to saturate the brush with paint and then removing the brush, to apply the paint to the surface being painted. The bucket may be placed on a support or held by the painter by grasping the metal wire handle. In such cases, the multipurpose bucket handle tool 10 of the present invention is used in order to obviate discomfort of holding the bucket for a long time.

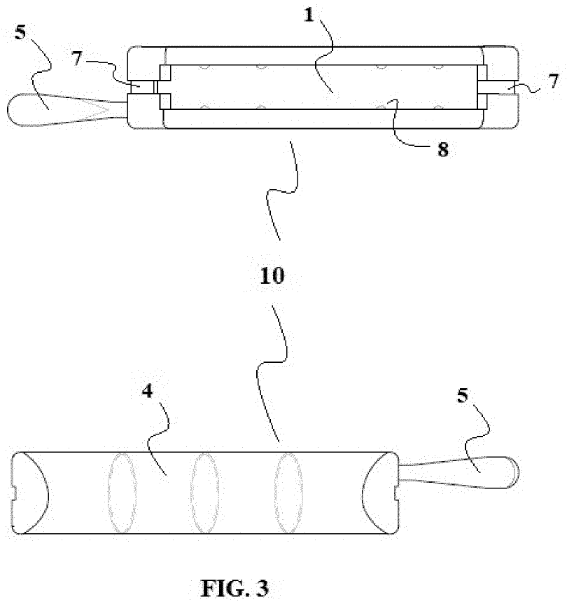

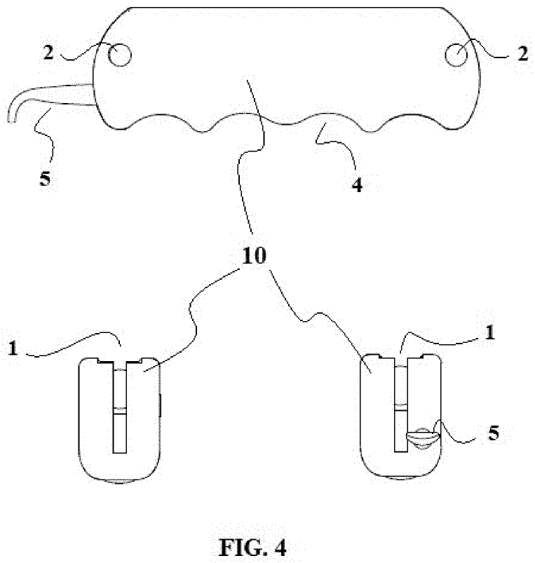

According to an embodiment of the present invention, a top and bottom view of the multipurpose bucket handle tool 10 is shown in FIG. 3. In the top view, the channel 1 is apparently visible in a rectangular shape with a narrow slit 7 provided at both ends to accept the bucket handle. Also, a plurality of protrusions 8 are bulging out from inside of the channel 1 to aid the secure placement of the multipurpose bucket handle tool 10 onto the standard bucket handle. In the bottom view, the plurality of indentations 4 are clearly visible which fit to the user's fingers for the perfect grip. Further, FIG. 4 is showing various side views of the multipurpose bucket handle tool 10.

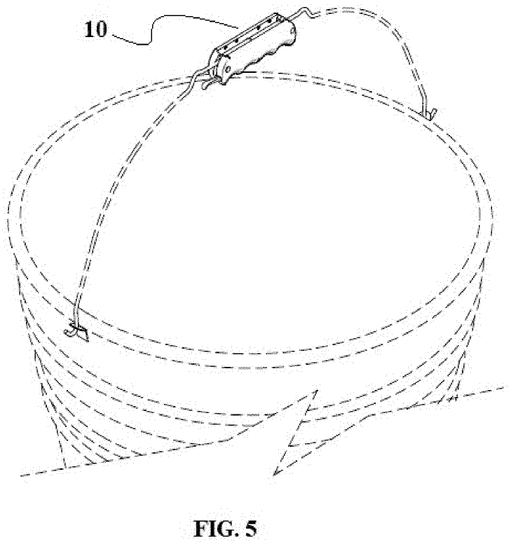

According to an embodiment of the present invention, an exemplary view of the bucket with the standard handle snapped by the multipurpose bucket handle tool 10 is shown in FIG. 5. In FIG. 5, it is clearly shown that the standard bucket handle of the metal wire is provided with an intended grip portion on which the multipurpose bucket handle tool 10 of the present invention can be easily snapped.

The multipurpose bucket handle tool of the present invention is highly advantageous over the conventional arts. The unique ergonomic design of the multipurpose bucket handle tool reduces the hand fatigue and provides the maximum comfort to the user. Moreover, the multipurpose bucket handle tool may be made up of materials which have a high durability to support tasks which require carrying and holding the bucket for long time. The tool therefore, serves more than one purpose including, but not limited to effective gripping, instant bucket lid opening, and easy storing. As a result, the multipurpose bucket handle tool of the present invention makes the bucket carrying and handling task less overwhelming which is further resulted into an increased productivity and related outcomes.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The invention has been explained in relation to specific embodiment. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

What is claimed is:

1. A multipurpose bucket handle tool, said tool comprising:
a channel, said channel is configured to securely snap onto a standard bucket handle and be held at a place by a plurality of magnets;
a plurality of apertures, said plurality of apertures are provided to insert the plurality of magnets for a secure placement;
a plurality of indentations, said plurality of indentations are provided at an outer bottom of said tool that conform to a user's hand to make a perfect;
a lid opener with a sharp end is extending outward from one of the side walls of said tool, said lid opener is configured to open a lid of a bucket; and
an aperture, said aperture is provided to securely place the lid opener inside it,
wherein magnetic fields generated by said plurality of magnets pass through to an interior of said channel, and grab on to said standard bucket handle for said secure placement.

2. The multipurpose bucket handle tool as claimed in claim 1, wherein said tool is ergonomically designed to reduce a hand fatigue and provide maximum comfort to the user.

3. The multipurpose bucket handle tool as claimed in claim 1, wherein said standard bucket handle is made up of a metal wire.

4. The multipurpose bucket handle tool as claimed in claim 1, wherein said plurality of magnets are utilized to hold said tool to anything which is attracted to said magnets, when said tool is not in use.

5. The multipurpose bucket handle tool as claimed in claim 1, wherein said channel is in a rectangular shape with a narrow slit provided at both ends to accept said standard bucket handle.

6. The multipurpose bucket handle tool as claimed in claim 1, wherein a plurality of protrusions are bulging out from inside of said channel to aid said secure placement of said tool onto said standard bucket handle.
